(19) United States
(12) Patent Application Publication
(10) Pub. No.: US 2023/0162249 A1
(43) Pub. Date: May 25, 2023

(54) SYSTEM TO IDENTIFY AND INTERACT WITH SELLERS

(71) Applicant: KonectAi, LLC, Houston, TX (US)

(72) Inventor: Inderpal Lehal, Delta (CA)

(73) Assignee: KonectAi, LLC, Houston, TX (US)

(21) Appl. No.: 17/456,542

(22) Filed: Nov. 24, 2021

(51) Int. Cl. G06Q 30/06; G06N 3/00

(52) U.S. Cl. CPC G06Q 30/0605; G06N 3/008

(57) ABSTRACT

A method of utilizing an artificial intelligence, AI, having language recognition software allowing the AI to have humanistic characteristics while interacting with the seller of used vehicle. The AI identifies online vehicles for sale and downloads the seller's contact information. The AI then validates or deletes the seller's contact information. The AI then interacts with a multiplicity of valid sellers to gather additional information on the vehicle as well as make an offer to purchase the vehicle.

### BACKGROUND

Generally, in the automotive retail sales industry automobile dealers there are several ways to acquire previously owned vehicles. A person interested in purchasing a new car would typically visit a local new car dealer and would then ultimately purchase a new car through their local new car dealer. Most of the time the person purchasing a new car would bring in his old car as a trade-in against the purchase price of the new car. The dealer would evaluate the trade in car and decide whether the dealer would want to keep it and resell the trade-in through the dealers used car sales outlet or the dealer would send the trade-in car to an auction house. In some instances, a dealer may not be able to acquire enough cars through trade-ins to sustain the dealer's used car sales. In those instances, rather than sending trade-ins to an auction the dealer may visit the auction in order to purchase additional vehicles for the dealer's used car business.

Recently, new car production has been unable to meet demand resulting in potential new car buyers purchasing a used car instead. Reduced new car sales results in fewer trade-ins so that the used car pool is reduced and fewer cars are being sent to auction. Current demand for used cars has outstripped supply.

Automobile dealers are struggling with a reduced supply of new cars to sell, fewer trade-ins coming in to support the automobile dealers used car businesses, and fewer cars at auctions where dealers would typically supplement the trade-ins going to their used car businesses.

Dealers are then forced to compete on the open retail market for used vehicles that fit the make, model, age, and price range of vehicles typically sold by their specific used car business. In order to compete effectively, dealers must search very large geographical areas and possibly tens of thousands of advertisements, many of which may be duplicate or inactive advertisements.

Having individuals search large geographical areas and tens of thousands of advertisements reduces the economic viability of the used car business to the point where it is no longer practical. Even utilizing a computer or computers to search large geographical areas and tens of thousands of advertisements across a multiplicity of marketplaces consumes excessive amounts Internet bandwidth, excessive amounts of data storage, and taxes computing capabilities.

What is needed is the ability to identify each opportunity and then contact each seller over a multiplicity of websites in real time. An embodiment of the invention will comb the various website for vehicle sales, contact the thousands or more sellers each day in real time to identify these opportunities i.e. these private sale opportunities through private websites. The artificial intelligence would engage with each individual seller, push the seller to the buyer, and/or facilitate the transaction before finally sending the seller's information to a buyer i.e. a physical person to finalize the transaction.

### SUMMARY

The following is an embodiment of the present invention. In order to efficiently utilize the various resources such as Internet bandwidth, data storage, or computer resources when searching online market places for entities wishing to sell used cars a multipronged search is utilized. An artificial intelligence will visit various online marketplaces to determine whether or not vehicles are being sold at that marketplace. The AI will then scour the marketplace to determine whether or not there are vehicles in that marketplace that fall within the bounds of the AI's search criteria. When the AI finds a vehicle that falls within the bounds of our search criteria the AI will then download the vehicle information in conjunction with the seller's contact information.

With the sellers contact information and related vehicle information downloaded into a database and AI will then compare the downloaded contact information to remove duplicates and then will ping the contact information to determine whether or not the contact information is valid. If the contact information is not valid the AI will delete the contact information from its database. By pinging sellers contact information to validate the contact information instead of sending a text or email and waiting for a reply, various resources are saved as it is no longer necessary to pursue each eliminated seller's contact information.

Once a seller's contact information is validated each of the sellers are then contacted by an AI. The AI interacts with each seller in order to acquire sufficient information such as VIN number, make, model, damage history, and mileage to allow the AI to make each seller an offer to purchase the seller's vehicle.

An embodiment of the current invention includes directing an artificial intelligence to access at least two websites, usually more than two. Each website includes a marketplace for vehicles. Searching the marketplace for individual vehicles for sale. Identifying the individual vehicles for sale that meet a predetermined criterion. Directing the artificial intelligence to impersonate a human when communicating with the multiple sellers. Validating the contact information for each of the individual vehicles for sale that meet the predetermined criteria. Generally, the AI will interact with 1000 or more sellers within a 24-hour period. While interacting with each seller the artificial intelligence will mimic human speech, timing, and colloquialisms

Another embodiment of the current invention includes interacting with multiple sellers to receive validated contact information. Directing the artificial intelligence to impersonate a human when communicating with the multiple sellers. Having the AI contact each validated seller. Requesting information on a vehicle advertised by the seller, confirming at least a portion of the information, and making an offer on the vehicle. Generally, the validated information includes the vehicle identification number. Once the AI has concluded a sale with the seller having accepted an offer, the seller is transferred to a human to close the transaction. The seller does not interact with a human except to close the transaction.

### BRIEF DESCRIPTION OF THE DRAWINGS

FIG. 1 is a flowchart representing the overall flow for contacting a multiplicity of sellers in an efficient manner.

FIG. 2 is a flowchart representing validating each potential sellers contact information.

FIG. 3 is a flowchart representing a preferred embodiment for having an AI in direct contact with the seller.

FIG. 4 is a close-up of portion A of the flowchart 100 from FIG. 3.

FIG. 5 is a close-up of portion B of the flowchart 100 from FIG. 3.

FIG. 6 is a close-up of portion C of the flowchart 100 from FIG. 3.

FIG. 7 is a flowchart representing an alternate embodiment for having an AI in direct contact with the seller.

### DETAILED DESCRIPTION

The description that follows includes exemplary apparatus, methods, techniques, or instruction sequences that embody techniques of the inventive subject matter. However, it is understood that the described embodiments may be practiced without these specific details.

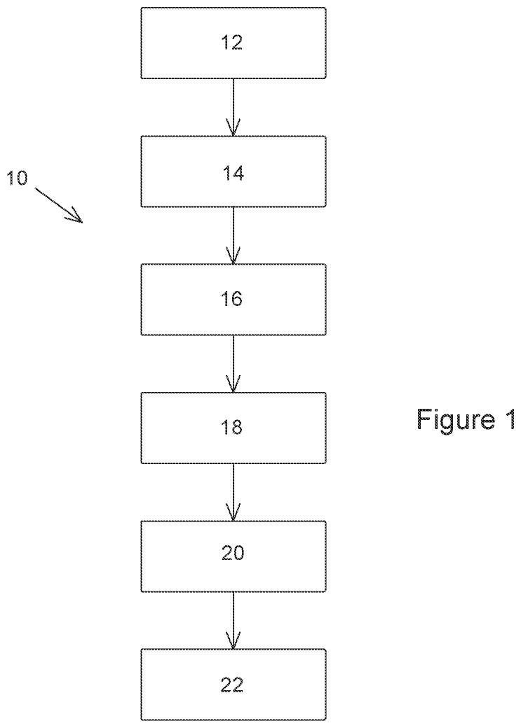

FIG. 1 is a flowchart describing the initial search routine 10. The Artificial Intelligence or AI begins by logging into multiple targeted websites as a user 12. The AI then utilizes a subroutine to identify the particular location within the website used as the marketplace 14. Once the marketplace has been identified the AI further identifies any material that may be construed as sales data for used vehicle 16. All identifying material 16 is then downloaded into a database 18. Each seller's contact information is then validated by the AI 20. With the seller's contact information validated the AI switches to the next phase of the system, contacting each seller to promulgate a sale 22.

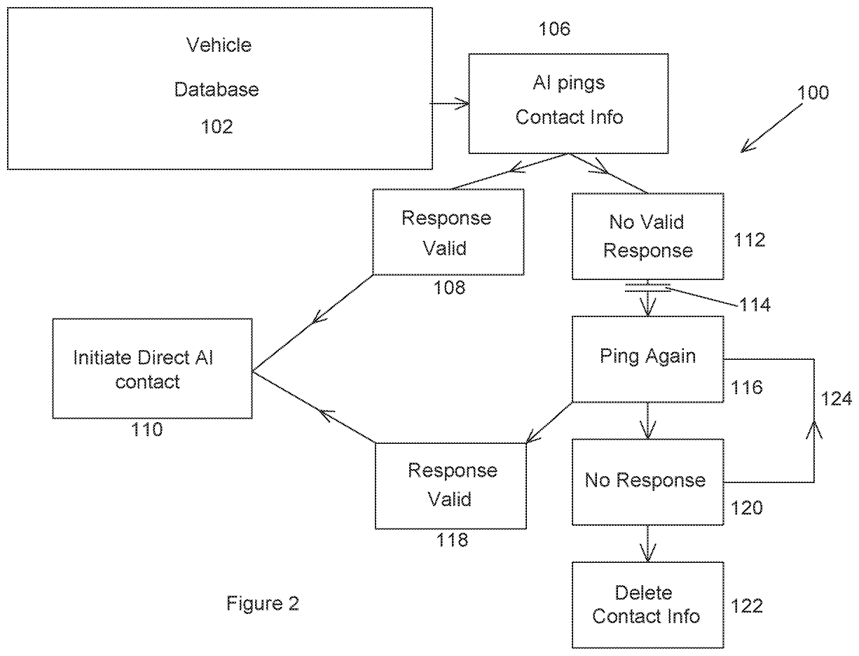

FIG. 2 is a flowchart 100 outlining the second phase of the system. In the second phase of the system, in order to avoid wasting communication resources such as internet bandwidth, computer time, or data storage the AI will ping the contact information relating to each seller in order to simply confirm whether or not the contact is an active phone number, email, text address, or other contact information. Typically, the AI begins the second phase by retrieving a particular set of contact information from the database 102. The AI then sends a ping to the contact information that was previously acquired, box 106. If the AI receives a response indicating that the contact information is valid, box 108, the AI will then initiate direct contact between the seller and the AI, box 110. In the event that there is no valid response received as indicated by box 112, the AI will wait some period of time as indicated by gap 114 before again sending a ping to the contact information that was previously acquired, box 116. In the event that the AI now receives a response indicating that the contact information is valid, box 118, the AI will then initiate direct contact between the seller and the AI, box 110. In the event that the AI again receives no response as indicated by box 120 the AI will loop back, as provided by line 124, to again ping the previously acquired contact information as indicated by box 116. In the event that the AI continues to receive no valid response from the previously acquired contact, after the AI goes through loop 124 a predetermined number of times and continues to receive no valid response the contact information is deleted.

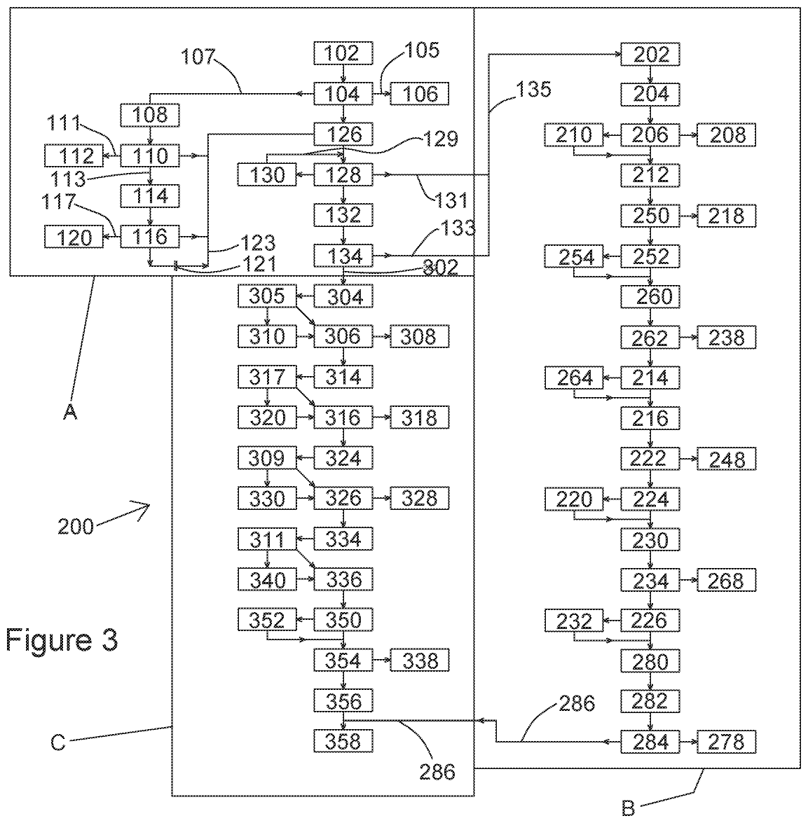

Once the seller's contact information is confirmed as a valid contact the AI initiates direct contact between the seller and the AI as indicated in box 110 of FIG. 2. FIG. 3 is a flowchart 200 outlining an embodiment of the AI's direct contact with each seller.

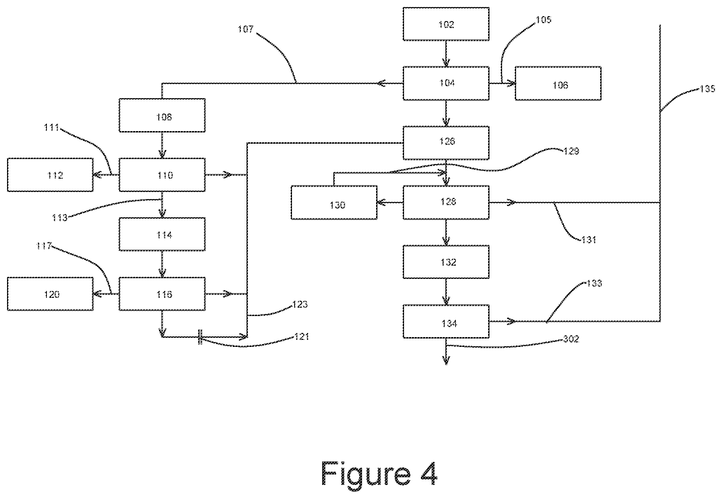

FIG. 4 is a close-up of portion A of FIG. 3. The AI initiates contact with the seller by engaging the seller in conversation. In this instance AI emulates human speech timing, mannerisms, colloquialisms, and other factors inherent in human speech to allow the contacted seller to believe that the contacted seller is engaged with another human or at least relax as if the contacted seller is engaged with another human.

In FIG. 4 box 102 represents the AI initiating contact with a seller. The AI attempts to confirm that the seller is interested in selling their vehicle, box 104. Sellers generally answer with yes, no, or maybe. If the seller indicates that they are no longer interested in selling their vehicle, arrow 105, the AI ends the conversation with the seller and removes the seller's contact information from the database, box 106. In the event the seller indicates, maybe, that they might be interested, arrow 107, the AI may provide additional marketing information and may ask for additional information about the vehicle for sale, box 106, in order to make an offer to buy the sellers vehicle. Again, sellers generally answer with yes, no, or maybe as indicated by, box 110. If the seller indicates that they are no longer interested in selling their vehicle, arrow 111, the AI ends the conversation with the seller and removes the seller's contact information from the database, box 112. In the event the seller indicates, maybe that they might be interested, arrow 113, the AI informs the seller that a bit of information, such as the VIN number, the license plate number, the accident history, and other questions related to the value of the vehicle, will be required in order to evaluate the vehicle, box 114. The AI will then ask the seller if the seller has that information, box 116. Sellers generally answer with yes, no, or that they need more time to gather the information. If the seller indicates that they are no longer interested in selling their vehicle, arrow 117, the AI ends the conversation with the seller and removes the seller's contact information from the database, box 120. In the event the seller indicates, that they need more time to gather the relevant information, then the AI will delay for a period of time as indicated by gap 121 before returning to box 126 via arrow 123.

At several points, box 104, box 110, and box 116, the seller has had the opportunity to make a decision. At each of these decision points, in the event that the seller answered yes at any of the decision points the AI would direct the seller to box 126. At box 126 the AI begins to collect the data related to the car, while the order of the data collected is not particularly important, the AI may begin by requesting the vehicle identification number or VIN, as indicated at box 126. The AI then checks the provided VIN against its database, box 128, in some instances the AI will determine that the VIN number does not match the car as originally described. In such instance the AI will ask the seller to check the VIN number and resend the VIN number as indicated by box 130. When the seller resends the VIN number as indicated by arrow 129 the AI will then again check the provided VIN number against its database, box 128. In the instance when the AI checks the VIN number and receives information that matches the car as originally described the AI will then confirm that information with the seller, box 132 by repeating back to the seller, information that identifies the vehicle such as the VIN number, the make and model of the vehicle, and some of the equipment in the vehicle such as number of doors, engine type, etc. Once the AI has repeated back to the seller the identifying information, the AI will ask the seller if that is correct, box 134. If at box 128 or box 134 the seller cannot provide a retrievable VIN number or the VIN number does not match the car type then as per arrows 131 and 133 the AI accesses a different technique to identify the vehicle that is for sale. In the event that the seller confirms the car's status as per box 134 the AI proceeds to the next question via line 302.

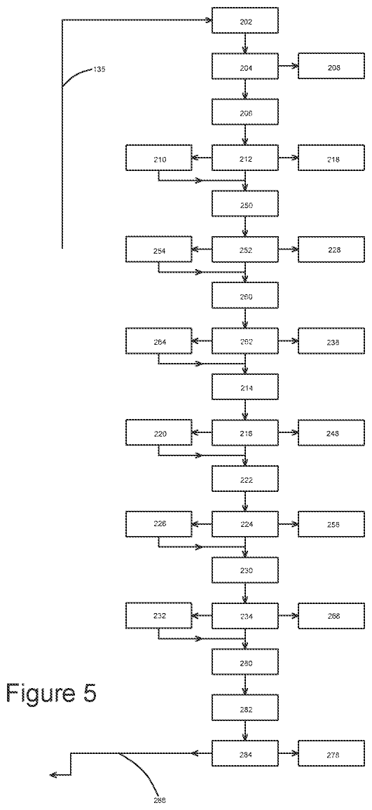

FIG. 5 is a close-up of portion B of FIG. 3. Arrows 131 and 133 from portion A combine into arrow 135 leading to box 202 where the AI interacts with the seller in a question-and-answer format to identify the vehicle for sale as well as the vehicle options when the VIN number is not available.

The AI typically begins this phase of interaction with the seller, box 202, by confirming the type of vehicle, car, truck, SUV, RV, motorcycle, boat, aircraft, heavy equipment, or other, for sale. The seller then confirms the type of vehicle, box 204. Next the AI asks the year of the vehicle, box 206. As part of the seller's decision process, the seller, in box 206 is offered an opportunity to terminate the interaction with the AI, as indicated by box 208. In some instances, the AI may require information in a specific format such as asking for the year the vehicle was manufactured, as indicated by box 210. Box 212 represents the AI's determination as to the year the vehicle was manufactured.

The AI requests the next piece of information, in this instance, information related to the manufacturer of the vehicle, box 250. As part of the seller's decision process, the seller, in box 250 is offered an opportunity to terminate the interaction with the AI, as indicated by box 218. The seller provides the manufacturer of the vehicle, box 252. In some instances, the AI will need the information in a specific format as indicated in box 254. Box 260 represents the AI's determination as to the manufacturer of the vehicle.

The AI requests the next piece of information, in this instance, information related to the model of the vehicle, box 262. As part of the seller's decision process, the seller, in box 262 is offered an opportunity to terminate the interaction with the AI, as indicated by box 238. The seller provides the model of the vehicle, box 214. In some instances, the AI will need the information in a specific format as indicated in box 264. Box 216 represents the AI's determination as to the model of the vehicle.

The AI requests the next piece of information, in this instance, information related to the trim of the vehicle, box 222. As part of the seller's decision process, the seller, in box 222 is offered an opportunity to terminate the interaction with the AI, as indicated by box 248. The seller provides the trim of the vehicle, box 224. In some instances, the AI will need the information in a specific format as indicated in box 220. Box 230 represents the AI's determination as to the trim of the vehicle.

The AI requests the next piece of information, in this instance, information related to the mileage of the vehicle, box 234. As part of the seller's decision process, the seller, in box 234 is offered an opportunity to terminate the interaction with the AI, as indicated by box 268. The seller provides the trim of the vehicle, box 226. In some instances, the AI will need the information in a specific format as indicated in box 232. Box 280 represents the AI's determination as to the trim of the vehicle.

Once all of the identifying information for the car has been provided by the seller the AI will have the seller provide additional personal information including the seller's name, the seller's legal name, seller's address seller's email address, and the sellers phone number, box 282.

With the sellers identifying information provided the AI moves to the next step providing an offer to purchase the sellers car as well as questioning the seller as to whether or not he is interested in the offer, box 282. The seller will then either indicate that they are interested in the offer or they are not interested in the offer, box 284. If the seller is interested then the AI directs the seller back to the main routine as indicated by line 286.

At various steps of the question-and-answer routine the seller is allowed the opportunity to end their interaction with the AI as indicated by boxes 208, 218, 238, 248, 268, and 278.

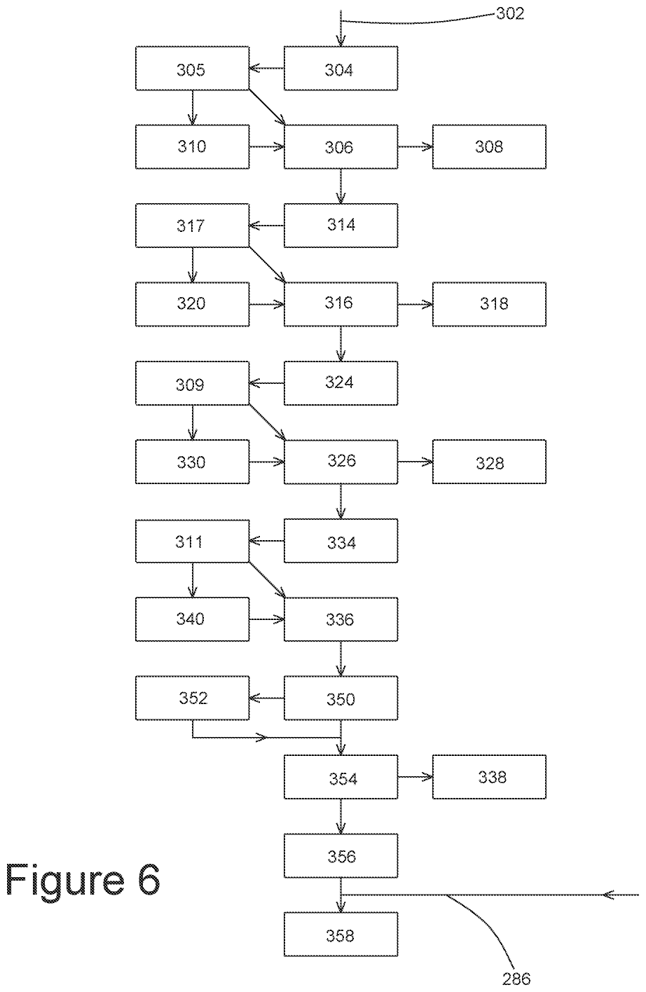

FIG. 6 is a close-up of portion B from FIG. 3. In the event that the seller confirms the cars status as per box 134, from FIG. 4, the AI proceeds to the next question, what is the color of the vehicle, box 304, via line 302.

The seller provides the color information for the vehicle, box 305. The AI then confirms the color of the vehicle, box 306. In some instances, the AI will need to ask for the information in a specific format as indicated in box 310. With the color confirmed the AI proceeds to the next question, in this case the vehicle's accident status, box 314.

The seller provides the accident status for the vehicle, box 317. The AI then confirms the accident status of the vehicle, box 316. In some instances, the AI will need to ask for the information in a specific format as indicated in box 320. With the accident status confirmed the AI proceeds to the next question, in this case the vehicle's repair status, box 324.

The seller provides the repair status for the vehicle, box 309. The AI then confirms the repair status of the vehicle, box 326. In some instances, the AI will need to ask for the information in a specific format as indicated in box 330. With the repair status confirmed the AI proceeds to the next question, in this case the vehicle's trim level or options, box 334.

The seller provides the trim level or options for the vehicle, box 311. The AI then confirms the trim level or options of the vehicle, box 336. In some instances, the AI will need to ask for the information in a specific format as indicated in box 340. With the trim level or options confirmed the AI proceeds to the next question, in this case does the seller have any photos of the vehicle, box 350.

In the event that the seller does have photos of the vehicle a field is provided for the seller to upload photos, box 352. Regardless of whether the seller has answered yes or no and the previously requested identifying information for the vehicle has been provided by the seller, the AI will have the seller provide additional personal information including the seller's name, the seller's legal name, seller's address seller's email address, and the sellers phone number, box 354.

With the sellers identifying information provided the AI moves to the next step providing an offer to purchase the sellers car as well as questioning the seller as to whether or not he is interested in the offer, box 356. The seller will then either indicate that they are interested in the offer or they are not interested in the offer, box 358.

At each step of the question-and-answer routine the seller is allowed the opportunity to end their interaction with the AI as indicated by boxes 308, 318, 328, and 338.

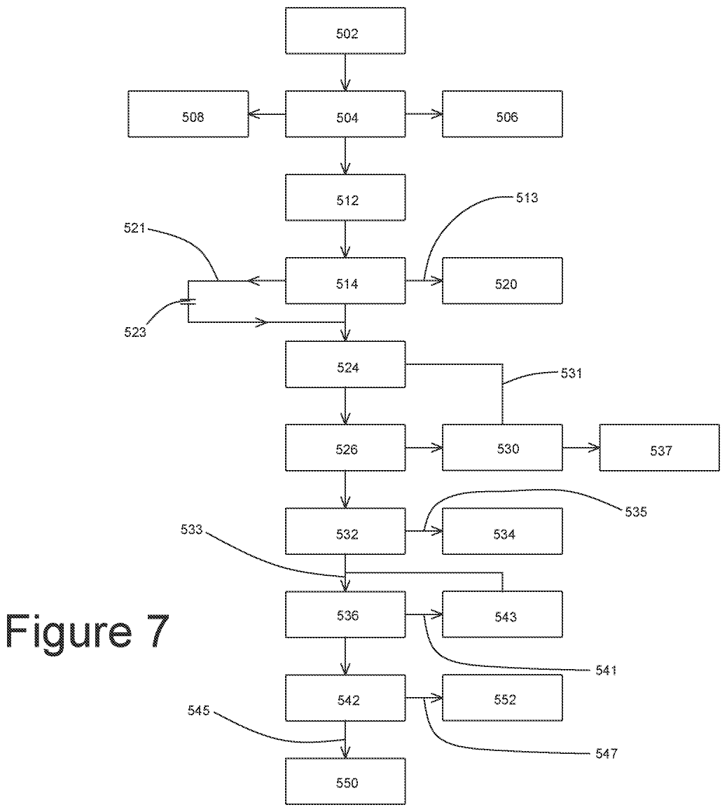

FIG. 7 is an alternative flowchart 500 outlining the AI's direct contact with each seller after the seller's contact information is confirmed as per FIG. 2.

Box 502 is the AI initiating contact with a seller to confirm that the seller is interested in selling their vehicle. Sellers generally answer with yes, no, or maybe, box 504. If the seller indicates that they are no longer interested in selling their vehicle, the AI ends the conversation with the seller and invites the seller to visit a website to receive a price for their vehicle, box 506. In the event the seller indicates, maybe, that they might be interested, the AI may direct the seller to a list of frequently asked questions, box 508.

In the event the seller indicates, yes, they are interested in selling their vehicle, the AI informs the seller that a bit of information, such as the VIN number, the license plate number, the accident history, and other questions related to the value of the vehicle, may be required in order to evaluate the vehicle, box 512. The AI will then ask the seller if the seller has that information, box 514. Sellers generally answer with yes, no, or that they need more time to gather the information. If the seller indicates that they are no longer interested in selling their vehicle, arrow 513, the AI ends the conversation with the seller and invites the seller to visit a website to receive a price for their vehicle, box 520. In the event the seller indicates, that they need more time to gather the relevant information, then the AI will delay for a period of time as indicated by gap 523 in arrow 521. If the seller answers in the affirmative, that yes, they do have the VIN number for the vehicle, the AI will ask the seller to enter the VIN number, box 524. The AI then checks the provided VIN against its database, box 526. In some instances, the AI will determine that the VIN number does not match the vehicle as originally described. In such instances, the AI will ask the seller to check the VIN number and resend the VIN number as indicated by box 530. The AI may also invite the seller to visit a website to receive a price for their vehicle, box 537. When the seller resends the VIN number as indicated by arrow 531 the AI will then again check the provided VIN number against its database, box 526.

The AI checks the VIN number and provided that the AI receives information that matches the car as originally described the AI will then confirm that information with the seller, box 532, by repeating back to the seller the information that identifies the vehicle such as the VIN number, the make and model of the vehicle, and some of the equipment in the vehicle such as number of doors, engine type, etc. The seller will then either confirm that the identifying information is correct as per arrow 533 or the seller will deny that the information is correct as per arrow 535. If the information is not correct then the AI invites the seller to visit a website to receive a price for their vehicle, box 534.

If the information is correct the AI proceeds to the next question, in this case, how many miles are on the vehicle, box 536. If the seller is unable to provide the mileage on the vehicle as per line 541 in the AI will inform the seller that the AI is unable to provide a price without mileage information and again invite the seller to provide the mileage as per box 543 directing the seller to again input the vehicle's mileage.

Provided that the seller enters the mileage information for the vehicle the AI moves to the next step, providing an offer to purchase the sellers car as well as questioning the seller as to whether or not he is interested in the offer, box 542. The seller will then either indicate that they are interested in the offer, line 545 or they are not interested in the offer, line 547. If the seller is interested then the AI directs the seller back to provide identifying information, box 550. If the seller is not interested in the offer, then the AI invites the seller to visit a website to receive a price for their vehicle, box 552.

Although an embodiment of the present invention has been described herein with reference to specific exemplary apparatus, methods, techniques, or instruction sequences that embody techniques of the inventive subject matter, it will be evident that various modifications and changes may be made to these embodiments without departing from the broader spirit and scope of the invention. Accordingly, the specification and drawings are to be regarded in an illustrative rather than a restrictive sense. The accompanying figures that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This description, therefore, is not to be taken in a limiting sense, and the scope of the various embodiments is defined only by the appended claims, along with the full range of equivalents to which such claims are entitled.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method of interacting with multiple sellers comprising:
directing an artificial intelligence to access at least two websites, wherein each website includes a marketplace for vehicles,
searching the marketplace for individual vehicles for sale,
identifying the individual vehicles for sale that meet a predetermined criterion,
directing the artificial intelligence to impersonate a human when communicating with the multiple sellers,
validating the contact information for each of the individual vehicles for sale that meet the predetermined criteria.

2. The method of interacting with multiple sellers of claim 1 wherein, the multiple sellers are at least 1000 sellers within a 24-hour period.

3. The method of interacting with multiple sellers of claim 1 wherein, the human impersonation includes the artificial intelligence utilizing human speech timing, and colloquialisms.

4. The method of interacting with multiple sellers of claim 1 wherein, the vehicles are automobiles.

5. A method of interacting with multiple sellers comprising:
receiving validated contact information,
directing the artificial intelligence to impersonate a human when
communicating with the multiple sellers,
contacting a seller,
requesting information on a vehicle advertised by the seller,
confirming at least a portion of the information,
making an offer on the vehicle

6. The method of interacting with multiple sellers of claim 5 wherein, the multiple sellers are at least 1000 sellers within a 24-hour period.

7. The method of interacting with multiple sellers of claim 5 wherein, the human impersonation includes the artificial intelligence utilizing human speech timing, and colloquialisms.

8. The method of interacting with multiple sellers of claim 5 wherein, the vehicles are automobiles.

9. The method of interacting with multiple sellers of claim 5 wherein, the portion of information includes the vehicle identification number.

10. The method of interacting with multiple sellers of claim 5 further comprising, transferring the seller and offer to a human to close the transaction.

11. The method of interacting with multiple sellers of claim 10 wherein, the seller does not interact with a human except to close the transaction
